(19) United States
(12) Patent Application Publication
(10) Pub. No.: US 2009/0089405 A1
(43) Pub. Date: Apr. 2, 2009

(54) FILE TRANSFER VIA ELECTRONIC MESSAGE

(75) Inventor: Joseph F. Mann, Waukesha, WI (US)

Correspondence Address: Fletcher Yoder Law;(for Rockwell Automation), P. O. Box 692289, Houston, TX, 77269-2289, US

(73) Assignee: Rockwell Automation Technologies, Inc., Mayfield, OH (US)

(21) Appl. No.: 11/862,881

(22) Filed: Sep. 27, 2007

(51) Int. Cl. G06F 15/177; G06F 15/173

(52) U.S. Cl. 709/220; 709/224

(57) ABSTRACT

An industrial automation system comprising an embedded system. The embedded system has hardware and firmware that enable the embedded system to perform its intended function. The hardware is adapted to enable the embedded system to communicate via a communications network. The firmware is adapted to enable the embedded systems to communicate using an Internet protocol suite. In addition, the hardware and firmware of the embedded system are adapted to enable the firmware to be revised by attaching the revisions to the firmware as an attachment to an e-mail sent to the embedded system. In addition, any information regarding the revision of the firmware, such as a problem in downloading the firmware revision, may be communicated to the sender via an e-mail program.

### BACKGROUND

The present invention relates generally to the field of programmable electrical devices, such as those used in industrial applications and other settings. More particularly, the invention relates to a technique for revising the programming of an embedded system used in an industrial automation system.

An embedded system is a special-purpose computer system designed to perform a dedicated function. Unlike a general-purpose computer, an embedded system is designed to perform one or a set of specific pre-defined tasks or functions. Because the embedded system is dedicated to performing such specific tasks or functions, the design of the embedded system may be optimized, enabling the size and cost of the product to be minimized. As a result, an embedded system typically includes task-specific hardware and software that are not usually found in a general-purpose computer, such as a personal computer. The software written for an embedded system is often called “firmware” and it may be stored in read-only memory, flash-memory and similar devices rather than a disk drive.

Embedded systems range from portable devices, such as MP3 players to large stationary installations, such as factory controllers or the systems controlling nuclear power plants. In addition, embedded systems may be found in medical equipment and automotive engine controllers. Embedded systems can also be found in videogames and home appliances, such as dishwashers and refrigerators. Embedded systems can also be found in control and monitoring systems, such as thermostats.

In fact, the field of control and monitoring systems is replete with various types of embedded systems. In industrial settings, for example, many sensors, actuators, relays, contactors, and other electrical and electronic devices are used, an increasing number are embedded systems that have limited programmability of their functions. For example, such devices may be programmed to retrieve data from or write data to certain registers (locally and of networked devices), make calculations based upon received data, and control themselves or other devices in certain situations.

Another class of embedded system used in industrial, commercial and other settings may be generally termed human machine interfaces. A typical human machine interface (HMI) used in industry, for example, may include programming for controlling various devices and processes, or may constitute a relatively simple panel that displays graphical configurations, sensed and monitored parameters, control settings, tables, and so forth. In industrial and process control systems, for example, these types of HMI are extremely common, and may be coupled to remote machinery, sensors, controllers, and even personal computers and workstations for monitoring parameters of complex systems, and controlling their operation.

Periodically, it may be desired to update the configuration of the firmware used by an embedded system. For example, a manufacturer of programmable devices may develop an improvement that may be made to the device firmware. Similarly, the manufacturer may discover a problem with an embedded system existing firmware and develop an update to correct the defect. Alternatively, a user of the embedded system may desire to make a change to its firmware. For example, a user may desire to revise the firmware for an HMI or a programmable logic controller to make it operate more efficiently. However, the manufacturers of embedded systems may use different proprietary protocols for communication with their embedded systems. Thus, a user may be required to have manufacturer proprietary software to communicate revisions to their embedded systems. For users having systems that utilize embedded systems from different manufacturers revising firmware may be especially difficult. This is especially true in large-scale industrial applications.

There is a need, therefore, for an improved technique that would enable the firmware in an embedded system, such as an HMI and a programmable logic controller, to be updated quickly and easily. Furthermore, there is a need for a technique to enable firmware used in embedded systems made by different manufacturers to be revised without the need for proprietary software from each of the different manufacturers.

### BRIEF DESCRIPTION

The present invention provides a unique approach to device configuration designed to respond to such needs. The invention may be used in a wide range of settings, but is particularly well-suited to electrical devices that reside in a communication network with other devices, particularly in industrial and similar settings. Moreover, the network in which the device is accessible may be a local network, based upon a conventional and industrial protocol, or may be an extended network, incorporating local area network protocols, wide area network protocols, and including the Internet.

In accordance with certain aspects of the invention, the firmware of electrical devices that reside in the network may be revised via an e-mail attachment sent to a communication network address corresponding to the electrical device, such as an HMI, a PLC, etc. In addition, any information regarding the revision of the firmware, such as a problem doing so, may be communicated to an interested party via an e-mail program.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of an exemplary implementation of a system for monitoring or controlling a process, in accordance with an exemplary embodiment of the present technique;

FIG. 2 is a diagrammatical overview of an exemplary implementation of a system for monitoring or controlling a process, in accordance with an alternative exemplary embodiment of the present technique;

FIG. 3 is a diagrammatical overview of an exemplary implementation of a system for monitoring or controlling a process, in accordance with a second alternative exemplary embodiment of the present technique; and

FIG. 4 is a diagrammatical overview of an exemplary implementation of a system for monitoring or controlling a process, in accordance with a third alternative exemplary embodiment of the present technique.

### DETAILED DESCRIPTION

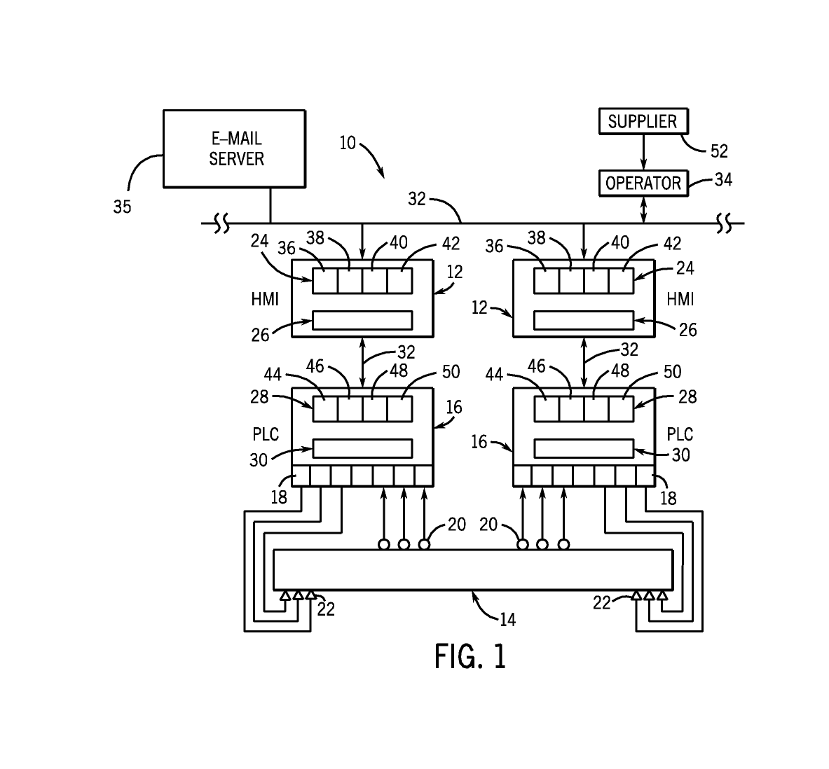

Turning now to the drawings, and referring first to FIG. 1, an exemplary control and monitoring system for industrial automation is presented, represented generally by reference numeral 10. The illustrated system 10 comprises at least one human machine interface (HMI) 12. Each HMI 12 is adapted to interface with networked components and process equipment, itself adapted to control and/or monitor an automation process or machine 14 to enable a user to control or monitor a process 14 remotely. In addition, an HMI 12 enables a user to manually interface with process equipment locally. Each HMI 12 may physically resemble a panel, monitor or stand-alone device. In the illustrated embodiment, the system 10 comprises a pair of HMIs 12.

In the illustrated embodiment, the process equipment comprises a plurality of control/monitoring devices 16 that are adapted to control the process 14 by operating one or more devices in response to one or more inputs received from process sensors and programming instructions stored within the control/monitoring device 16. A control/monitoring device 16 may be a programmable logic controller (PLC), or some other device adapted to control components, typically various actuators, and/or monitor one or more physical parameters of the process 14 based on the programming within the firmware stored within the control/monitoring device 16 or an HMI 12. However, separate devices may be used for control and monitoring of the automation process or machine 14. In this embodiment, each control/monitoring device 16 utilizes a series of registers 18 to communicate with sensors 20 and actuators 22 that enable the control/monitoring devices 16 to control and monitor the process 14. However, other means of communicating with sensors 20 and actuators 22 may be used. The sensors 20 may comprise any number of devices adapted to provide information regarding process parameters, such as digital thermometers, pressure sensors, RPM meters, flow meters, etc. The actuators 22 may similarly include any number of devices adapted to perform a mechanical or electrical action in response to a control signal from the control/monitoring device 16. The control/monitoring device 16 may interact with a variety of control and/or monitoring devices, such as electric motors, valves, actuators, sensors, or a myriad of manufacturing, processing, material handling and other applications to monitor and control the operation of the compressor station, the oil refinery, the batch operation for making food items, the mechanized assembly line, etc.

In addition, each HMI 12 is adapted to enable a user to interface with one or more control/monitoring devices 16. For example, an HMI 12 may be used to change the set point for the control/monitoring device 16 to initiate functions of an actuator 22. In addition, or alternatively, an HMI 12 may have a monitor to enable a user to see a visual representation of a process parameter, or parameters, detected by one or more sensors 20.

In the illustrated embodiment, each HMI 12 and control/monitoring device 16 is an embedded system. Each HMI 12 has hardware 24 and firmware 26 that are adapted to cooperate to enable the HMI 12 to perform its intended function or functions. In addition, each control/monitoring device 16 has its own hardware 28 and firmware 30 that are adapted to cooperate to enable each control/monitoring device 16 to perform its intended function or functions. In both cases, the firmware directs the operation of the hardware.

The system 10 utilizes a communication network 32 to enable the various components of the system 10 to communicate with one another. In the illustrated embodiment, the network 32 is a local area network (LAN). However, the network 32 may be or include the Internet, or some other network. The network 32 enables an operator to communicate with the HMIs 12 and control/monitoring devices 16 via an operator workstation 34. The operator workstation 34 enables a user to receive and transmit information to the HMIs 12 and control/monitoring devices 16 from a remote location. In this embodiment, the operator workstation 34 is a personal or general purpose computer. However, the operator workstation 34 may be a handheld device, or any of a myriad of similar devices that enable a user to communicate via a communications network, such as a LAN or the Internet. In addition, each HMI 12 and control/monitoring device 16 has a unique communication network address.

The network 32 enables changes, such as revisions or updates, to be made to the firmware for both an HMI 12 and a control/monitoring device by sending the changes to each HMI 12 and control/monitoring device 16 as a file attachment in an e-mail message. In the illustrated embodiment, the e-mail may be sent from the operator workstation 34 to each HMI 12 and control/monitoring device 16 via an e mail server 35. In addition, changes to the firmware 30 of the control/monitoring device 16 may be made by the HMI 12. As with the operator workstation 34, an e-mail with the revision in the download file attachment may be sent from the HMI 12 to the control/monitoring device 16.

In the illustrated embodiment, the firmware in each HMI 12 and control/monitoring device 16 is programmed to enable the HMI 12 and control/monitoring device 16 to communicate using the Internet protocol suite, also known as the TCP/IP protocol suite. The TCP/IP protocol suite is the set of communications protocols that implement the protocol stack on which the Internet and most commercial networks run. The TCP/IP protocol suite was named after two of the most important protocols in it: the Transmission Control Protocol (TCP) and the Internet Protocol (IP), which were the earliest data communication networking protocols defined.

In addition, the Internet protocol suite stored in the firmware in each HMI 12 and control/monitoring device 16 has an e-mail transmission protocol, such as the SMTP (Simple Mail Transport Protocol or the ESMTP (Extended Simple Mail Transport Protocol), which rides on top of the Internet protocol suite. Essentially, SMTP is the standard for e-mail transmissions across the Internet. SMTP is a text-based protocol, where one or more recipients of a message are specified (and in most cases verified to exist) and then the message text is transferred. SMTP is a client-server protocol, where the client transmits an e-mail message to the server. An end-user's e-mail client, i.e., a MUA (Mail User Agent) or a relaying server's MTA (Mail Transfer Agents) can act as an SMTP client. An e-mail client knows the outgoing mail SMTP server from its configuration. A relaying server typically determines which SMTP server to connect to by looking up the MX (Mail eXchange) DNS (Domain Name System) record for each recipient's domain name. The SMTP client then initiates a TCP connection to a server's port.

SMTP does not allow a user to “pull” e-mail messages from a remote server on demand. Instead, SMTP is a “push” protocol that delivers the e-mail message to a client. To obtain an e-mail message, an e-mail client typically uses a program, such as POP3 (Post Office Protocol version 3) or IMAP (Internet Message Access Protocol). Another SMTP server can trigger a delivery in SMTP using ETRN (Extended Turn). POP3 is an application-layer Internet standard protocol to retrieve e-mail from a remote server over a TCP/IP connection. IMAP is an application layer Internet protocol operating on port 143 that allows a local client to access e-mail on a remote server. ETRN is an extension to the SMTP e-mail protocol. ETRN enables a mail server to request a second mail server to forward outstanding mail messages to it. The second mail server should initiate a new SMTP connection back to the first server. Some level of security is provided by DNS-based authentication of the initiating server.

In this embodiment, the hardware 24 for each HMI 12 comprises a buffer 36, an executable memory 38, a processor 40, and additional hardware 42. The processor 40 directs the operation of the HMI 12 based on the programming stored in the executable memory 38. The applicable firmware 26 for the operation is stored in the executable memory 38. The buffer 36 is able to store the data in a file sent as an attachment in a standard e-mail until the desired changes to the firmware 26 may be made. When the operation of the device enables the changes to be made, the data in the file stored in the buffer 36 is transferred to the executable memory 38 and processed by the processor 40 and the requested changes to the firmware 26 are made. The additional hardware 42 may comprise a number of different hardware devices 24, such as I/O devices, a monitor, buttons, etc. As noted above, the firmware also includes programming to enable the HMI 12 to communicate using the TCP/IP protocol suite and SMTP. Therefore, revisions to an HMI firmware may be made using standard e-mail programs stored in the firmware; the operating system of the operator workstation 34; and the mail server 35, rather than by proprietary software.

By using standard e-mail programs, information about the attached file can be conveyed to the operator workstation using standard e-mail information messages. For example, if there is a problem in downloading the attached file, an information message can be sent back to the operator station 34 via e-mail that discloses important information about the file. More specifically, if the file is not compatible with the firmware in the HMI 12, a “file not compatible” error message is sent to the operator workstation 34.

Similarly, each control/monitoring device 16 has its own hardware 28 that comprises a buffer 44, executable memory 46, a processor 48, and additional hardware 50 in the illustrated embodiment. The processor 40 directs the operation of the control/monitoring device 16. The executable memory 46 stores the firmware programming that is used to direct the operation of the processor 48. The buffer 44 is able to store the data in a file sent as an attachment in a standard e-mail until the desired changes to the executable memory 46 may be made. As with the HMI 12 described above, when the operation of the device enables the changes to be made, the data in the file stored in the buffer 44 is transferred to the executable memory 46 and processed by the processor 48 and the requested changes to the firmware 30 are made. The additional hardware 50 may comprise a number of different hardware devices 24, such as I/O devices, a monitor, buttons, etc.

As with the firmware 26 of the HMI 12, the firmware 30 of the control/monitoring device 16 also includes programming to enable the control/monitoring device 16 to communicate using the TCP/IP protocol suite. Therefore, as with the HMI 12, revisions to the control/monitoring device 16 firmware may be made using a standard e-mail program stored in the firmware 30 of the control/monitoring device 16 and the operating system of the operator workstation 34, rather than the use of proprietary software. Similarly, information regarding the file is sent to the operator workstation 34 via standard e-mail return/receipt messaging. In addition to standard return/receipt messages, such as “error 33,” the messaging text may also be in the local language where the device is located, such as English, Spanish, French, or German.

In addition to an operator, changes to the firmware for the HMIs 12 or the control/monitoring devices 16 may be initiated by an external entity, such as a supplier or manufacturer. In the illustrated embodiment, a supplier may send an e-mail containing a file having a desired revision/update from an external entity workstation 52 to the operator workstation 34. In this embodiment, the operator at the operator workstation 34 controls access to the HMIs 12 and control/monitoring device 16. Thus, the operator controls if and when the desired revision/update is made to the firmware. If the change is desired by the operator, the e-mail containing the file attachment may be forwarded to the desired component, i.e., one or more of the HMIs 12 or control/monitoring devices 16. In addition, an HMI 12 may be used to control revisions to a control/monitoring device 16. For example, an e-mail containing an attachment to revise a control/monitoring device 16 may be routed through the HMI 12. Before the e-mail is forwarded to the control/monitoring device 16, a user may have to approve the e-mail at the HMI 12.

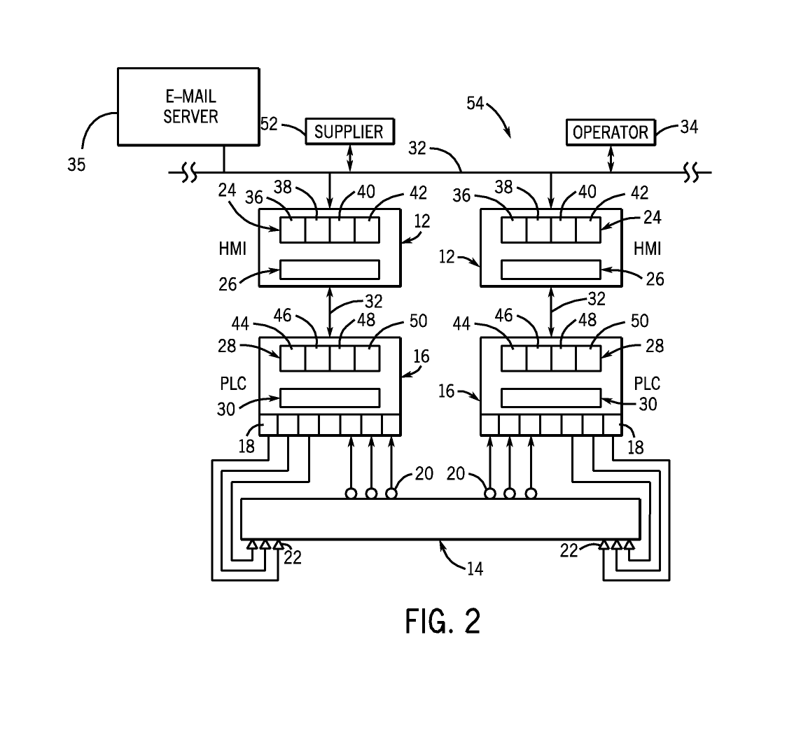

Referring generally to FIG. 2, an alternative embodiment of a control and monitoring system for industrial automation is presented, represented generally by reference numeral 54. In this embodiment, changes to the firmware for each HMI 12 or the control/monitoring devices 16 may be made by an external entity, such as a supplier or manufacturer. In the illustrated embodiment, the external entity workstation 52 is able to connect to the network 32. In this embodiment, the network 32 is the Internet. This enables the external entity to send an e-mail containing a file having a desired revision/update from the external entity workstation 52 to each HMI 12 and control/monitoring device 16.

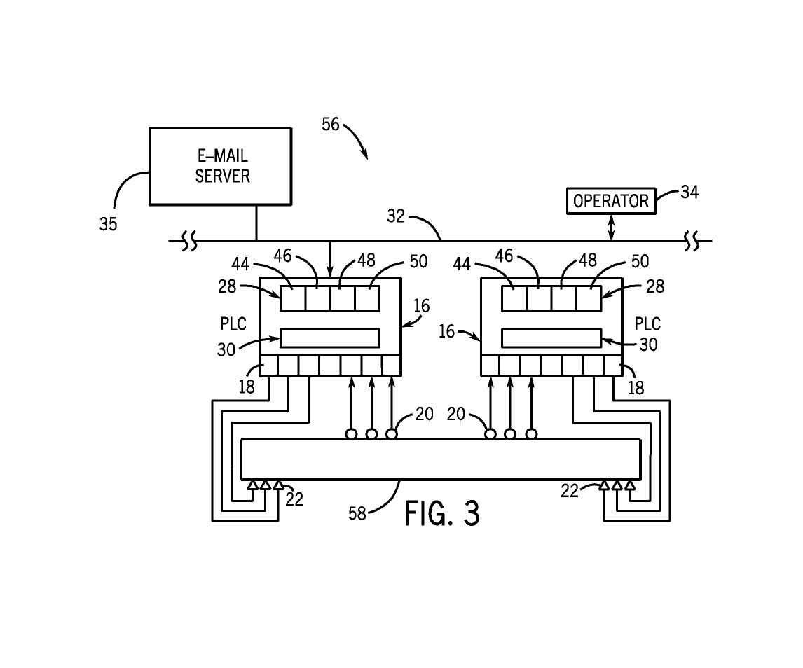

Referring generally to FIG. 3, a second alternative embodiment of a control and monitoring system for industrial automation is presented, represented generally by reference numeral 56. In this embodiment, there are no HMIs 12 in the illustrated system 56. The system 56 utilizes PLCs to control and monitor a process 58. The hardware 28 and firmware 30 are configured to enable the PLC to communicate with the operator's workstation 34 via the network 32 using SMTP and the TCP/IP protocol suite. Changes to the control/monitoring devices 16 may be made using an operator's workstation 34. As above, changes to the firmware 30 for the control/monitoring devices 16 may be made by sending an e-mail containing a file having a desired revision/update from the operator's workstation 34 to the control/monitoring devices 16. Any information, such as a problem in downloading the file from the e-mail, may be transmitted back to the source of the e-mail, or an alternate email recipient.

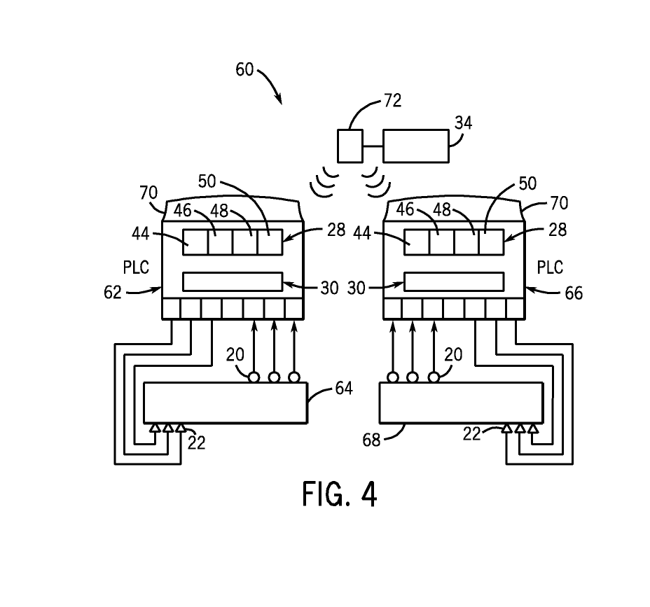

Referring generally to FIG. 4, a third alternative embodiment of a control and monitoring system for industrial automation is presented, represented generally by reference numeral 60. The illustrated system 60 comprises a first PLC 62 to monitor and control a first process 64 and a second PLC 66 to monitor and control a second process 68. Alternatively, the first process 64 and second process 68 may be different stages of the same process. In this embodiment, the communication network is a wireless network. The connectivity could be as part of a WAN (wide area network), a LAN (local area network), or a PAN (personal area network). As above, the first PLC 62 and second PLC 66 are configured to communicate using the SMTP and TCP/IP protocol suite. Each of the illustrated PLCs has a wireless communication device 70 to enable each PLC 62, 66 to communicate wirelessly with an operator's workstation 34. The operator workstation 34 has a wireless modem 72 to enable the operator to communicate with each PLC 62, 66. Alternatively, a radio transmitter, a cellular phone system, WiFi, Bluetooth, or some other wireless communications system may be used to communicate information.

As described more fully above, changes to the firmware 30 for each PLC 62, 66 may be made by sending an e-mail containing a file having a desired revision/update from the operator workstation 34 to each PLC 62, 66. Any information, such as a problem in downloading the file from the e-mail, may be transmitted from a PLC back to the source of the e-mail or any alternate email recipient.

It should be noted that, while reference is made in the present discussion to networked systems and to systems incorporating HMIs 12, PLCs, and other equipment, the techniques described herein may be equally well applied to networked systems outside the industrial automation field. For example, the arrangements and processes described below may be used in facilities management, automotive and vehicular interfaces, computer numeric control (CNC) machines, point of sale (POS) systems, control interfaces for commercial markets (e.g., elevators, entry systems), and so forth, to mention only a few.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of configuring an embedded system of an industrial automation system, comprising:
transmitting a file adapted to configure operation of an embedded system of an industrial automation system to the embedded system by e-mail;
downloading the file from the e-mail to the embedded system of the industrial automation system; and
processing the file to configure the operation of the embedded system.

2. The method as recited in claim 1, wherein transmitting a file adapted to configure operation of an embedded system of an industrial automation system to the embedded system by e-mail comprises transmitting the file based on an Internet protocol suite.

3. The method as recited in claim 2, comprising:
storing an application within the embedded system to enable the embedded system to communicate using an Internet protocol suite.

4. The method as recited in claim 3, wherein the Internet protocol suite is an email protocol.

5. The method as recited in claim 1, wherein transmitting a file adapted to configure operation of an embedded system of an industrial automation system to the embedded system by e-mail comprises transmitting the file adapted to configure operation of an embedded system as an attachment to an e-mail message.

6. The method as recited in claim 5, wherein downloading the file from the e-mail to the embedded system of the industrial automation system comprises downloading the attachment to an e-mail message into a buffer.

7. The method as recited in claim 6, wherein processing the file to configure the operation of the embedded system comprises processing data in the buffer.

8. The method as recited in claim 1, comprising:
transmitting an information message regarding the downloading of the file from the e-mail to the embedded system to a sender of the e-mail as an e-mail message.

9. An industrial automation system, comprising:
an embedded system operable to at least one of control a device and monitor a parameter of a process, the embedded system being coupleable to a communications network, wherein the embedded system comprises:
firmware to enable the embedded system to use the communications network to communicate based on an Internet protocol suite; and
a buffer to enable the embedded system to store data temporarily from a file sent as an attachment in an e-mail message sent via the communications network and based on the Internet protocol suite.

10. The industrial automation system as recited in claim 9, wherein the Internet protocol suite comprises an email protocol.

11. The industrial automation system as recited in claim 9, wherein the embedded system is adapted to receive data from a sensor.

12. The industrial automation system as recited in claim 9, wherein the embedded system is adapted to transmit control signals to an actuator of a device.

13. The industrial automation system as recited in claim 9, wherein the embedded system comprises a human machine interface adapted to enable a user to at least one of transmit data to the embedded system and receive data from the embedded system.

14. The industrial automation system as recited in claim 9, comprising:
a processor; and
executable memory adapted to store firmware for processing by the processor, wherein data stored temporarily in the buffer is transferred to the executable memory for processing.

15. A method of operating an industrial automation system, comprising:
transmitting a file adapted to modify operation of an embedded system of an industrial automation system by e-mail from a first electrical device to the embedded system of the industrial automation system;
downloading the file from the e-mail to the embedded system of the industrial automation system; and
transmitting information regarding the attempt to download the file from the embedded system to the first electrical device by e-mail.

16. The method as recited in claim 15, wherein transmitting a file adapted to modify operation of an embedded system of an industrial automation system by e-mail comprises transmitting the file based on an e-mail transmission protocol.

17. The method as recited in claim 16, comprising:
storing an application within the embedded system to enable the embedded system to communicate using an Internet protocol suite.

18. The method as recited in claim 15, wherein the information regarding the attempt to download the file comprises a standard e-mail error message in a localized language.

19. The method as recited in claim 15, wherein transmitting a file adapted to modify operation of an embedded system of an industrial automation system by e-mail from a first electrical device to the embedded system of the industrial automation system comprises transmitting a file adapted to modify operation of an embedded system within a human machine interface operable to send a control signal to a process control device.

20. The method as recited in claim 15, wherein transmitting a file adapted to modify operation of an embedded system of an industrial automation system by e-mail from a first electrical device to the embedded system of the industrial automation system comprises transmitting a file adapted to modify operation of an embedded system within a human machine interface operable to receive a signal from a process monitoring device.

21. The method as recited in claim 15, wherein the embedded system is a process control device connected to the first electrical device by a network and having an Internet Protocol address.

22. The method as recited in claim 15, wherein the embedded system is a process monitoring device connected to the first electrical device by a network and having an Internet Protocol address.
